(19) United States
(12) Patent Application Publication
(10) Pub. No.: US 2025/0320092 A1
(43) Pub. Date: Oct. 16, 2025

(54) CRANE SITE OBSTACLE DETERMINATION SYSTEM AND CRANE

(71) Applicant: SUMITOMO HEAVY INDUSTRIES, LTD., Tokyo (JP)

(72) Inventor: Yasuhiro YAMAMOTO, Yokosuka-shi (JP)

(21) Appl. No.: 19/247,640

(22) Filed: Jun. 24, 2025

Related U.S. Application Data
(63) Continuation of application No. PCT/JP2023/046563, filed on Dec. 26, 2023.

(30) Foreign Application Priority Data
Dec. 27, 2022 (JP) 2022-209922

(51) Int. Cl. B66C 23/88; B66C 13/46; B66C 13/48

(52) U.S. Cl. CPC B66C 23/88; B66C 13/46; B66C 13/48

(57) ABSTRACT

A crane site obstacle determination system that determines an obstacle with respect to a suspended load of a crane. The system includes: an obstacle position identification unit that identifies a position of the obstacle based on obstacle position designation information transmitted from an obstacle side; and an entry prohibition range determination unit that determines an entry prohibition range of the crane including the obstacle identified by the obstacle position identification unit.

### CROSS-REFERENCE TO RELATED APPLICATIONS

This is a bypass continuation of International PCT Application No. PCT/JP2023/046563, filed on Dec. 26, 2023, which claims priority to Japanese Patent Application No. 2022-209922, filed on Dec. 27, 2022, which are incorporated by reference herein in their entirety.

### BACKGROUND

### Technical Field

Certain embodiments of the present invention relate to a crane site obstacle determination system and a crane.

### Description of Related Art

The related art discloses a crane in which an obstacle detection sensor can detect an obstacle with which a jib, a suspended load wire, and a suspended load member of the crane may come into contact.

### SUMMARY

According to an embodiment of the present invention, a crane site obstacle determination system determines an obstacle with respect to a suspended load of a crane. The system includes an obstacle position identification unit that identifies a position of the obstacle based on obstacle position designation information transmitted from an obstacle side; and an entry prohibition range determination unit that determines an entry prohibition range of the crane including the obstacle identified by the obstacle position identification unit.

According to another embodiment of the present invention, a crane is a crane used by the crane site obstacle determination system, in which an operation of the crane is restricted, or a worker is notified in a case where a suspended load of the crane enters the entry prohibition range.

### BRIEF DESCRIPTION OF THE DRAWINGS

FIG. 1 is a diagram showing a crane site obstacle determination system according to a first embodiment.

FIG. 2A is a diagram showing a display unit of an operator's cabin.

FIG. 2B is a diagram showing the display unit of the operator's cabin.

FIG. 3 is a control block diagram of a crane site obstacle determination system.

FIG. 4 is a flowchart showing an operation state of the crane site obstacle determination system.

FIG. 5 is a diagram of an obstacle identification unit constituting a crane site obstacle determination system according to a second embodiment.

FIG. 6 is a diagram showing a crane site obstacle determination system according to a third embodiment.

FIG. 7 is a diagram showing a crane site obstacle determination system according to a fourth embodiment.

FIG. 8 is a diagram showing a crane site obstacle determination system according to a fifth embodiment.

FIG. 9 is a block diagram showing a configuration of an aerial vehicle and a remote control device according to a fifth embodiment.

FIG. 10 is a flowchart showing an example of a procedure for position setting processing of an obstacle in the fifth embodiment.

### DETAILED DESCRIPTION

However, in the technique of the related art, the obstacle is autonomously determined on the crane side. However, what is treated as an obstacle varies depending on the site. For example, whether or not an object is treated as an obstacle may vary depending on the shape of the suspended load or the like. Therefore, there is an issue in that processing of data acquired by the obstacle detection sensor becomes complicated.

According to the present invention, the position of the obstacle can be identified based on the obstacle position designation information transmitted from the obstacle side. Therefore, the obstacle determination on site can be more easily performed.

Hereinafter, each embodiment will be described in detail with reference to the drawings.

### First Embodiment

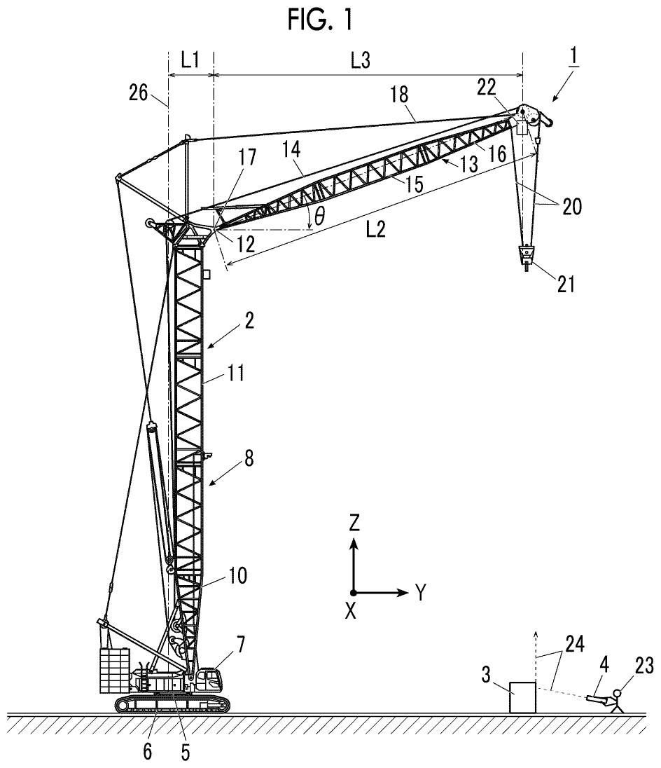

FIG. 1 is a diagram showing a crane site obstacle determination system 1 according to a first embodiment. The crane site obstacle determination system 1 shown in FIG. 1 includes a crane 2 and an obstacle identification unit 4 that identifies an obstacle 3 positioned at a work site. In the following crane site obstacle determination system 1, irrespective of a forward direction (a direction in which a rotating platform 6 is facing) of a lower traveling body 5 of the crane 2, a predetermined forward direction of the lower traveling body 5 is referred to as “front”, a backward direction as “rear”, a left hand side when facing forward as “left”, and a right hand side when facing forward as “right”. In addition, unless otherwise specified, in principle, a front-rear direction of the crane 2 will be described assuming that the rotating platform 6 is in a state (reference posture) in which the front-rear direction of the rotating platform 6 coincides with the front-rear direction of the lower traveling body 5. In addition, there is also a case where an up-down direction in a state in which the crane 2 is placed on a horizontal plane is referred to as a vertical direction.

As shown in FIG. 1, the crane 2 has the rotating platform 6 rotatably mounted on the lower traveling body 5. An operator's cabin 7 is installed on the rotating platform 6, and a tower boom 8 is attached to stand upright. The rotating platform 6, the operator's cabin 7, and the tower boom 8 are integrated with each other to be rotatable.

The tower boom 8 is composed of a lower tower boom 10, an intermediate tower boom 11, an upper tower boom 12, and the like. A tower jib 13 is connected to the upper tower boom 12. The tower jib 13 is composed of a lower tower jib 14, an intermediate tower jib 15, an upper tower jib 16, and the like. The tower jib 13 has a lower end of the lower tower jib 14 connected to a pivot fulcrum 17 at an upper end of the upper tower boom 12 to be capable of derricking, and is derricked around the pivot fulcrum 17 as a jib pendant rope 18 is operated. A hook 21 is attached to an upper end (tip) side of the upper tower jib 16 via a suspended load rope 20. In addition, a camera 22 serving as an image acquisition unit is attached to an upper end (tip) side of the upper tower jib 16. The camera 22 is capable of imaging a work site from the sky. In addition, the camera 22 receives a laser beam 24 (obstacle position designation information) emitted from a laser irradiation device (for example, a laser pointer) serving as the obstacle identification unit 4 operated by a site worker and reflected by the obstacle 3. It is preferable that an image of the entire work site is captured by the camera 22 attached to the upper end side of the upper tower jib 16 during pre-work inspection of a rotation range limiting device of the crane 2. The camera 22 is not limited to a monocular camera, and a CCD camera, a stereo camera, or the like may be used. In addition, the obstacle identification unit 4 is not limited to the laser irradiation device, and includes a portable terminal (for example, a smartphone), a beacon, a light-emitting unit such as an LED, a detachable marker, and a dedicated remote terminal.

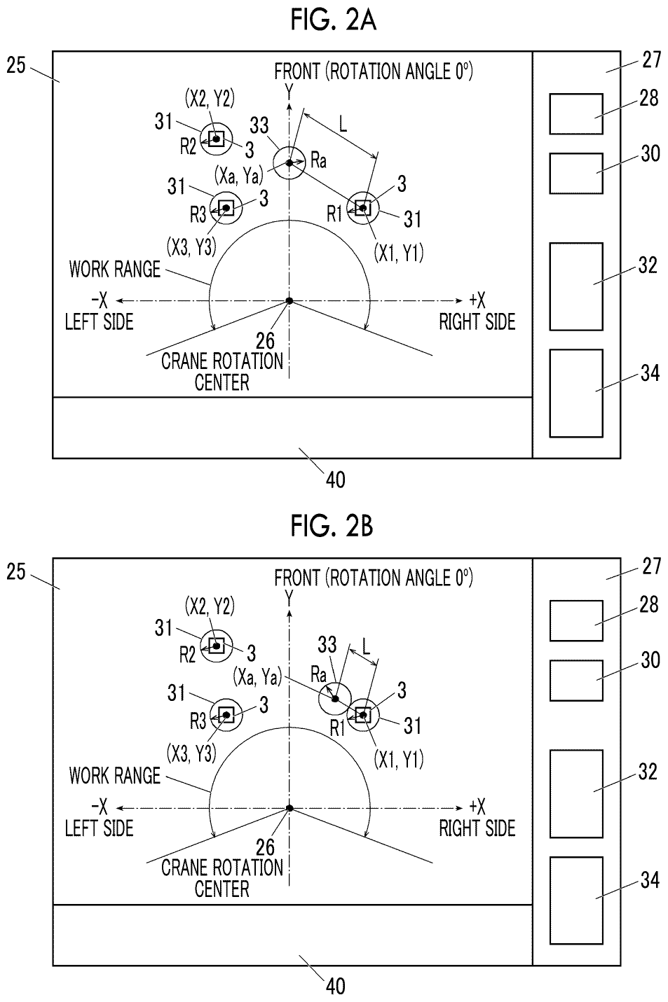

FIGS. 2A and 2B are views showing a display unit 25 of the operator's cabin 7 installed in the rotating platform 6. FIG. 2A is a diagram of the display unit 25 showing a state before the operation (before the rotation) of the rotating platform 6, and is an image of the work site captured by the camera 22 from the sky. In addition, FIG. 2B is a diagram of the display unit 25 showing a state in which the rotating platform 6 is rotated in a clockwise direction, and is an image of the work site captured from the sky.

As for the operator's cabin 7, in a case where the crane 2 is remotely operated, a remote operator's cabin separate from the crane 2 can be used as an operator's cabin in which the display unit 25 is installed.

As shown in FIG. 2A, the display unit 25 is a touch panel monitor, and displays an image on an X-Y coordinate plane parallel to a horizontal plane. On the X-Y coordinate plane in the display unit 25, in a state before the rotating platform 6 of the crane 2 rotates, a direction from a rotation center 26 of the rotating platform 6 toward the front of the crane 2 is a Y-axis direction, a direction from the rotation center 26 of the rotating platform 6 toward the right side of the crane 2 is an X-axis direction, and an intersection point between the X-axis and the Y-axis is the rotation center 26 of the rotating platform 6.

In addition, as shown in FIG. 2A, an operation unit 27 is integrally provided on the right side of the display unit 25. An obstacle position identification button serving as an obstacle position identification unit 28, a monitored object position identification button serving as a monitored object position identification unit 30, an entry prohibition range determination unit 32 that forms an entry prohibition range 31, and a monitored object range determination unit 34 that forms a monitored object range 33 are installed in the operation unit 27. The monitored object is the hook 21 or a suspended load suspended from the hook 21.

The display unit 25 shown in FIG. 2A displays the obstacle 3 irradiated with a laser beam, and after an operator presses the obstacle position identification button 28 of the operation unit 27, the operator can identify obstacle positions (X1, Y1), (X2, Y2), and (X3, Y3) by touching the obstacle 3 displayed on the display unit 25 with his or her finger or a stylus, and can display the obstacle positions (X1, Y1), (X2, Y2), and (X3, Y3) on the display unit 25 with red circles or the like. The obstacle positions (X1, Y1), (X2, Y2), and (X3, Y3) are stored in a storage unit 35 as position data on the X-Y coordinate plane.

In addition, as the operator presses the monitored object position identification button 30 of the operation unit 27, the display unit 25 shown in FIG. 2A displays a monitored object position (Xa, Ya) with a colored point (for example, a blue circle point) different from the obstacle positions (X1, Y1), (X2, Y2), and (X3, Y3).

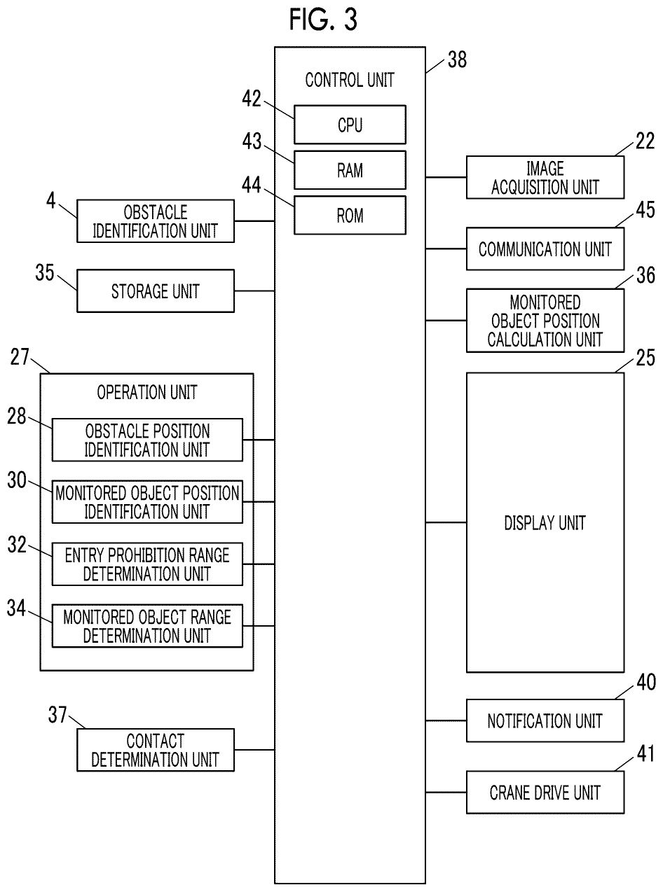

The monitored object position (Xa, Ya) is calculated by a monitored object position calculation unit 36 (refer to FIG. 3). The monitored object position calculation unit 36 calculates the position (Xa, Ya) on the X-Y coordinate plane based on a distance LI in a Y direction from the rotation center 26 of the rotating platform 6 to the pivot fulcrum 17 on a lower end side of the lower tower jib 14, a distance L3 in the Y direction from the pivot fulcrum 17 on the lower end side of the lower tower jib 14 to a position immediately above the hook 21, and a rotation angle of the rotating platform 6. Then, the monitored object position (Xa, Ya) is displayed on the display unit 25 when the monitored object position identification button 30 of the operation unit 27 is turned on. The distance L3 can be obtained by L2cose when the derricking angle of the tower jib 13 is 0 and the length of the tower jib 13 (the length from the pivot fulcrum 17 on the lower end side of the lower tower jib 14 to the position immediately above the hook 21) is L2.

Next, after the obstacle position (X1, Y1) is displayed, when the entry prohibition range determination unit 32 of the operation unit 27 is operated, followed by the operation of the obstacle position identification unit 28, and a radius R1 of the entry prohibition range 31 is selected from a pull-down menu, the display unit 25 displays a circle (entry prohibition range 31) having the radius RI centered on the obstacle position (X1, Y1). Then, the obstacle position (X1, Y1) and the radius R1 of the entry prohibition range 31 are stored in the storage unit 35 and are used for the calculation of the contact determination in a contact determination unit 37.

In addition, after an obstacle position (X2, Y2) is displayed, when the entry prohibition range determination unit 32 of the operation unit 27 is operated, followed by the operation of the obstacle position identification unit 28, and a radius R2 of the entry prohibition range 31 is selected from the pull-down menu, the display unit 25 displays a circle (entry prohibition range 31) having the radius R2 centered on the obstacle position (X2, Y2). Then, the obstacle position (X2, Y2) and the radius R2 of the entry prohibition range 31 are stored in the storage unit 35 and are used for the calculation of the contact determination in the contact determination unit 37.

In addition, after an obstacle position (X3, Y3) is displayed, when the entry prohibition range determination unit 32 of the operation unit 27 is operated, followed by the operation of the obstacle position identification unit 28, and a radius R3 of the entry prohibition range 31 is selected from the pull-down menu, the display unit 25 displays a circle (entry prohibition range 31) having the radius R3 centered on the obstacle position (X3, Y3). Then, the obstacle position (X3, Y3) and the radius R3 of the entry prohibition range 31 are stored in the storage unit 35 and are used for the calculation of the contact determination in the contact determination unit 37 (refer to FIGS. 2A and 3).

In addition, after the monitored object position (Xa, Ya) is displayed, when the monitored object range determination unit 34 of the operation unit 27 is operated, followed by the operation of the monitored object position identification unit 30, and a radius Ra of the monitored object range 33 is selected from the pull-down menu, the display unit 25 displays a circle (monitored object range 33) having the radius Ra centered on the monitored object position (Xa, Ya). The monitored object position (Xa, Ya) and the monitored object range 33 are stored in the storage unit 35 in an associated state. When the hook 21 (or the suspended load) of the crane 2 moves, the monitored object position (Xa, Ya) of the display unit 25 is calculated by the monitored object position calculation unit 36 every predetermined time, and is displayed on the display unit 25 together with the monitored object range 33 to move in association with the movement of the hook 21 (or the suspended load) of the crane 2 (refer to FIGS. 2B and 3).

As shown in FIG. 2B, when the monitored object position (Xa, Ya) and the monitored object range 33 move on the display unit 25 with the movement of the monitored object (hook 21 or suspended load) of the crane 2, and the circle indicating the monitored object range 33 comes into contact with the circle indicating the entry prohibition range 31, the distance L between the monitored object position (Xa, Ya) and the obstacle position (X1, Y1) is equal to the sum (R1+Ra) of the radius R1 of the entry prohibition range 31 and the radius Ra of the monitored object range 33 (L=R1+Ra). A relationship between the monitored object range 33 and the entry prohibition range 31 is calculated by the contact determination unit 37 (refer to FIG. 3). When the contact determination unit 37 calculates that the distance L between the monitored object position (Xa, Ya) and the obstacle position (X1, Y1) is equal to the sum (R1+Ra) of the radius R1 of the entry prohibition range 31 and the radius Ra of the monitored object range 33 (L≤R1+Ra), the control unit 38 outputs a control signal to a notification unit 40, causes a display screen of the notification unit 40 disposed on a lower side of the display unit 25 to display that there is a risk of contact between the monitored object (hook 21 or suspended load) and the obstacle 3, and causes a speaker of the notification unit 40 to issue a warning sound. In addition, the notification unit 40 may be provided with a lamp that blinks and emits light when a control signal is input from the control unit 38.

In addition, when the contact determination unit 37 calculates that the distance L between the monitored object position (Xa, Ya) and the obstacle position (X1, Y1) is equal to the sum (R1+Ra) of the radius R1 of the entry prohibition range 31 and the radius Ra of the monitored object range 33 (L=R1+Ra), the control unit 38 outputs a control signal to a crane drive unit 41 to restrict the operation of the crane drive unit 41. The restriction of the crane drive unit 41 by the control unit 38 reduces the driving speed of the crane 2 or stops the driving of the crane 2. In addition, the restriction of the crane drive unit 41 by the control unit 38 automatically controls the driving of the crane 2 such that the monitored object (hook 21 or suspended load) of the crane 2 does not collide with the obstacle 3 and such that the distance L between the monitored object (hook 21 or suspended load) and the obstacle 3 is (L>R1+Ra).

FIG. 3 is a control block diagram of the crane site obstacle determination system 1. As shown in FIG. 3, the control unit 38 is, for example, a computer including a CPU 42, a RAM 43, a ROM 44, and the like. In the present embodiment, the CPU 42 reads out various processing programs stored in the ROM 44 to deploy the processing programs in a work area of the RAM 43 in response to an operation signal input from the operation unit 27, an instruction signal received via a communication unit 45, or the like, and comprehensively controls the driving of the crane 2 in cooperation with the various programs deployed in the RAM 43.

The control unit 38 receives the captured image of the work site and the image of the obstacle 3 from the camera 22 serving as the image acquisition unit in a state in which the images are A/D-converted, and stores the image data in the storage unit 35. In addition, the laser beam 24 (obstacle position designation information), which is emitted from the laser irradiation device (for example, a laser pointer) as the obstacle identification unit 4 and reflected by the obstacle 3, is A/D-converted via the camera 22 and input to the control unit 38, and is stored in the storage unit 35.

In addition, a control signal from the outside and various data transmitted from a drone or the like are input to the control unit 38 via the communication unit 45. Then, the control signal and various data input to the control unit 38 via the communication unit 45 are stored in the storage unit 35.

In addition, the position data of the monitored object (hook 21 or suspended load) calculated by the monitored object position calculation unit 36 is input to the control unit 38. Then, the position data of the monitored object (hook 21 or suspended load) is stored in the storage unit 35.

When the display unit 25 is turned on, the control unit 38 causes the captured image of the work site acquired by the camera 22 and the image of the obstacle 3 irradiated with the laser beam 24 to be displayed on the X-Y coordinate plane of the display unit 25.

In addition, when the obstacle position identification unit 28 of the operation unit 27 is operated and the image of the obstacle 3 displayed on the touch panel constituting the display unit 25 is touched by the operator with his or her finger or a stylus, the control unit 38 receives the position data (X1, Y1), (X2, Y2), and (X3, Y3) of the obstacle 3 on the X-Y coordinate plane from the display unit 25 side. Thus, the control unit 38 causes the storage unit 35 to record the position data of the obstacle 3 and causes the touch panel to display a colored point indicating the position of the obstacle 3 (refer to FIGS. 2A and 2B).

In addition, when the monitored object position identification unit 30 of the operation unit 27 is operated, the control unit 38 causes the monitored object position (Xa, Ya) calculated by the monitored object position calculation unit 36 to be displayed on the X-Y coordinate plane of the display unit 25 as colored points in colors different from the colored points of the obstacle positions (X1, Y1), (X2, Y2), and (X3, Y3) (refer to FIGS. 2A and 2B).

In addition, when the obstacle position identification unit 28 of the operation unit 27 is operated and the obstacle position (for example, the position of X1, Y1) of the display unit 25 is touched by the operator, and then the entry prohibition range determination unit 32 of the operation unit 27 is operated and the radius R1 of the entry prohibition range 31 is selected from the pull-down menu, the control unit 38 causes the storage unit 35 to store the selected radius R1 in association with the obstacle position (X1, Y1), and causes the display unit 25 to display a circle (entry prohibition range 31) having the radius RI centered on the obstacle position (for example, the position of X1, Y1).

In addition, when the monitored object position identification unit 30 of the operation unit 27 is operated, and then the monitored object range determination unit 34 is operated, and the radius Ra of the monitored object range 33 is selected from the pull-down menu, the control unit 38 causes the storage unit 35 to store the selected radius Ra in association with the monitored object position (Xa, Ya), and causes the display unit 25 to display a circle (monitored object range 33) having the radius Ra centered on the monitored object position (Xa, Ya).

In addition, the control unit 38 executes any one of the following processing 1 or processing 2. That is, as the processing 1, when the crane 2 operates such that the monitored object (the hook 21 or the suspended load) moves on the X-Y coordinate plane and the contact determination unit 37 determines that the monitored object range 33 and the entry prohibition range 31 are in contact with each other, the control unit 38 outputs a control signal to the notification unit 40, causes the display screen of the notification unit 40 to display that there is a risk of contact between the monitored object (hook 21 or suspended load) and the obstacle 3, and causes the speaker of the notification unit 40 to issue a warning sound. In addition, as the processing 2, when the contact determination unit 37 determines that the monitored object range 33 and the entry prohibition range 31 are in contact with each other, the control unit 38 outputs a control signal to the crane drive unit 41 and restricts the operation of the crane drive unit 41. Either one of the processing 1 or the processing 2 is selected, or both are selected and executed.

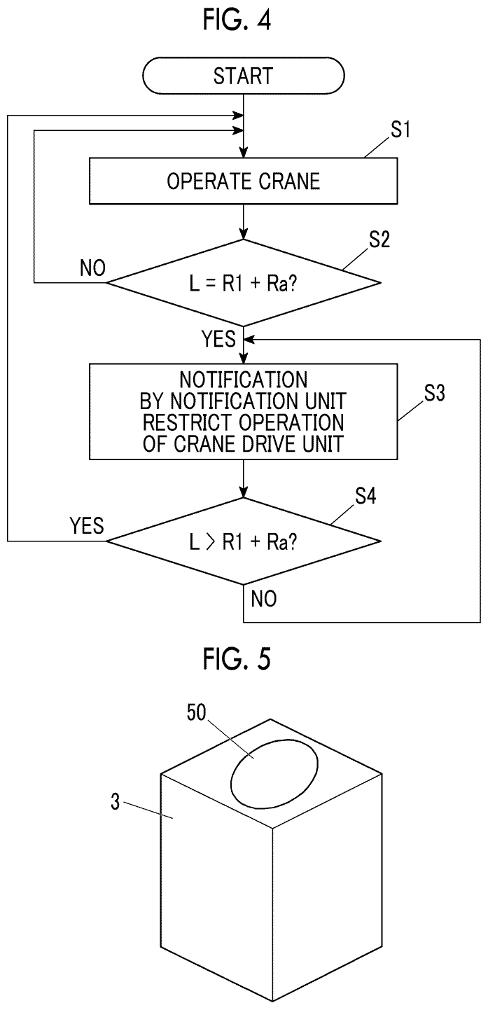

FIG. 4 is a flowchart showing an operation state of the crane site obstacle determination system 1. As shown in FIG. 4, when the crane 2 operates (step S1), the monitored object (hook 21 or suspended load) is transported by the crane 2, the monitored object (hook 21 or suspended load) moves on the X-Y coordinate plane of the display unit 25, and the contact determination unit 37 determines that the monitored object range 33 and the entry prohibition range 31 come into contact with each other on the X-Y coordinate plane of the display unit 25 (step S2), the control unit 38 outputs a control signal to the notification unit 40, and the notification unit 40 notifies the operator that there is a risk of collision between the monitored object (hook 21 or suspended load) and the obstacle 3 with an alarm sound or the like, and the control unit 38 outputs a control signal to the crane drive unit 41 to restrict the operation of the crane drive unit 41 (step S3). Thereafter, when the crane 2 is operated by the operator, and the distance between the obstacle 3 and the monitored object (hook 21 or suspended load) is increased (L>R1+Ra) (step S4), the crane 2 is normally operated by the control unit 38 (step S1). On the other hand, even when the crane 2 is operated by the operator, in a case where the distance between the obstacle 3 and the monitored object (hook 21 or suspended load) is not increased (in a case where L>R1+Ra is not established), the notification by the notification unit 40 and the restriction of the crane drive unit 41 are continued (steps S3 and S4).

Since the crane site obstacle determination system 1 according to the present embodiment as described above can identify the position of the obstacle 3 based on the obstacle position designation information transmitted from the obstacle 3 side, information can be prevented from being input from an object that is not problematic as the obstacle 3, and the obstacle determination on site can be more easily performed.

In addition, since the crane site obstacle determination system 1 according to the present embodiment acquires the laser beam (specific light) of the laser irradiation device reflected from the obstacle 3 with the camera 22, the obstacle 3 can be easily identified based on the specific light.

In the crane site obstacle determination system 1 according to the present embodiment, the obstacle position can be identified by the operator touching the obstacle 3 displayed on the display unit 25 with his or her finger or a stylus. However, the present invention is not limited thereto. For example, the laser beam (obstacle position designation information) received by the camera 22 may be processed by an obstacle position identification program or the like recorded in the storage unit 35, and may be identified and displayed as the obstacle position on the X-Y coordinate plane of the display unit 25. In addition, the identification of the obstacle position and the determination of the entry prohibition range may be performed by a portable information terminal.

### Second Embodiment

FIG. 5 is a diagram for illustrating a second embodiment of the crane site obstacle determination system according to the present invention, and is a diagram of an obstacle identification unit constituting the crane site obstacle determination system. In addition, since a crane of the crane site obstacle determination system according to the present embodiment is the same as the crane of the crane site obstacle determination system according to the first embodiment, the description of the crane will be omitted.

As shown in FIG. 5, the obstacle identification unit of the crane site obstacle determination system according to the present embodiment is composed of a marker 50 that reflects light. The marker 50 is formed of a material having high light reflection efficiency, and is detachably attached to a position where the natural light of the obstacle 3 is easily reflected. The marker 50 is attached to the obstacle 3 by a worker positioned around the obstacle 3. In addition, the marker 50 is not limited to one that reflects light, and may be a light-emitting body that emits light by itself. The marker 50 and the light-emitting body are obstacle identification units that function as light-emitting units, and the light emitted from the marker 50 or the light-emitting body becomes obstacle position designation information. In addition, when the marker 50 having a shape that is easy to distinguish from an object at a work site is used, the position of the obstacle 3 is easily recognized.

In the crane site obstacle determination system according to the present embodiment, the light from the marker 50 of the obstacle 3 is incident into the camera, and the light of the marker 50 becomes the obstacle position designation information transmitted from the obstacle 3 side.

The crane site obstacle determination system according to the present embodiment is the same as the crane site obstacle determination system according to the first embodiment in that the position of the obstacle 3 can be identified based on the obstacle position designation information transmitted from the obstacle 3 side. Therefore, even though the configuration is simple, the obstacle determination on site can be more easily performed.

### Third Embodiment

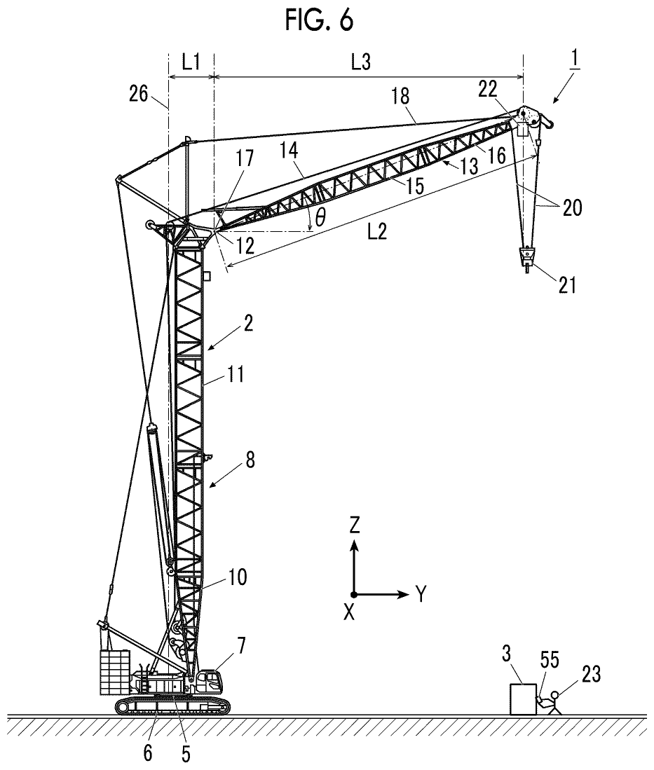

FIG. 6 is a diagram showing a third embodiment of the crane site obstacle determination system 1 according to the present invention, and is a diagram showing a modification example of the obstacle identification unit constituting the crane site obstacle determination system 1. In addition, since the configuration of the crane 2 of the crane site obstacle determination system 1 according to the present embodiment is the same as that of the crane 2 of the crane site obstacle determination system 1 according to the first embodiment, the same components as those of the crane 2 of the crane site obstacle determination system 1 according to the first embodiment are denoted by the same reference numerals, and the duplicate description will be omitted.

In the crane site obstacle determination system 1 according to the present embodiment, the obstacle identification unit is a portable information terminal 55 (a portable terminal such as a smartphone or tablet) having a GPS function. Simply by going to the position of the obstacle 3 and operating the portable information terminal 55, a site worker 23 can transmit position information from the portable information terminal 55, and the position information (X1, Y1) of the obstacle 3 is simply input to the control unit via the communication unit, so that the entry prohibition range 31 can be determined. Therefore, in the present embodiment, the position information of the obstacle 3 transmitted from the portable information terminal 55 becomes the obstacle position designation information transmitted from the obstacle 3 side. The portable information terminal 55 has a GPS (first relative position detection sensor) function for acquiring a relative position between the crane 2 and the portable information terminal 55. The information (GPS information) from the portable information terminal is included in the obstacle position designation information.

As in the crane site obstacle determination system 1 according to the first embodiment, the crane site obstacle determination system 1 according to the present embodiment can identify the position of the obstacle 3 based on the obstacle position designation information transmitted from the obstacle 3 side. Therefore, the obstacle determination on site can be more easily performed.

### Modification Example of Third Embodiment

The obstacle identification unit 4 of the crane site obstacle determination system 1 according to a modification example of the third embodiment may be configured by combining a portable information terminal having a GNSS function and capable of acquiring position information with a ranging device such as a LiDAR, and may transmit distance data to an obstacle acquired by the ranging device and position information acquired by an information terminal to the control unit 38 of the crane 2 to identify the position of the obstacle 3 based on the data acquired by the information terminal and the ranging device.

The obstacle identification unit 4 of the present modification example is configured by combining a portable information terminal having a GNSS function (function as a first relative position detection sensor for acquiring a relative position between the crane 2 and the portable information terminal 55) and a ranging device such as a LiDAR having a function as a second relative position detection sensor capable of measuring a relative position between the obstacle 3 and the portable information terminal 55. The information transmitted from the portable information terminal 55 and the ranging device is the obstacle position designation information.

As in the crane site obstacle determination system 1 according to the first embodiment, the crane site obstacle determination system 1 according to the modification example of such a third embodiment can identify the position of the obstacle 3 based on the obstacle position designation information transmitted from the obstacle 3 side. Therefore, the obstacle determination on site can be more easily performed.

In addition, the obstacle identification unit 4 of the crane site obstacle determination system 1 according to the present modification example can acquire the position information of the obstacle 3 at a position away from the obstacle 3.

### Fourth Embodiment

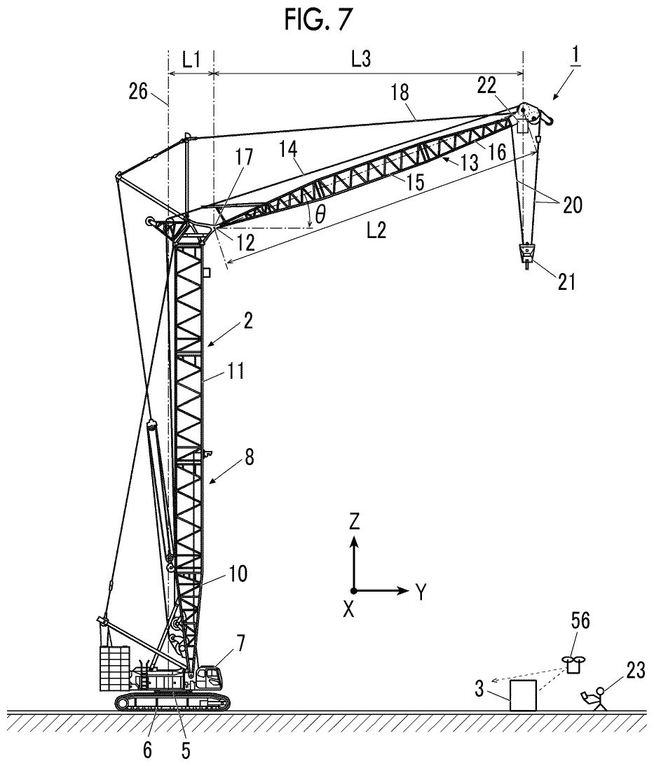

FIG. 7 is a diagram showing a fourth embodiment of the crane site obstacle determination system 1 according to the present invention, and is a diagram showing a modification example of the obstacle identification unit constituting the crane site obstacle determination system 1. In addition, since the configuration of the crane 2 of the crane site obstacle determination system 1 according to the present embodiment is the same as that of the crane 2 of the crane site obstacle determination system 1 according to the first embodiment, the same components as those of the crane 2 of the crane site obstacle determination system 1 according to the first embodiment are denoted by the same reference numerals, and the duplicate description will be omitted.

In the crane site obstacle determination system 1 according to the present embodiment, the obstacle identification unit is an aerial vehicle 56 (for example, a drone) having a GPS function and a distance measurement function. By operating the aerial vehicle 56 at a position away from the obstacle 3, the site worker 23 can easily acquire the position information of the obstacle 3 at the position away from the site worker with the aerial vehicle 56, and as the position information of the obstacle 3 acquired by the aerial vehicle 56 is transmitted from the aerial vehicle 56, the position information (X1, Y1) of the obstacle 3 is input to the control unit via the communication unit. Therefore, in the present embodiment, the position information of the obstacle 3 transmitted from the aerial vehicle 56 becomes the obstacle position designation information transmitted from the obstacle 3 side. In the present embodiment, the obstacle identification unit has been described as the aerial vehicle 56 that flies. However, the obstacle identification unit is not limited to this as long as the obstacle identification unit can approach the periphery of an obstacle. For example, the obstacle identification unit may be a moving body that moves along the ground or along a building under construction.

As in the crane site obstacle determination system 1 according to the first embodiment, the crane site obstacle determination system 1 according to the present embodiment can identify the position of the obstacle 3 based on the obstacle position designation information transmitted from the obstacle 3 side. Therefore, the obstacle determination on site can be more easily performed.

In addition, the aerial vehicle 56 (obstacle identification unit 4) of the crane site obstacle determination system 1 according to the present modification example can acquire the position information of the obstacle 3 at a position away from the obstacle 3.

### Fifth Embodiment

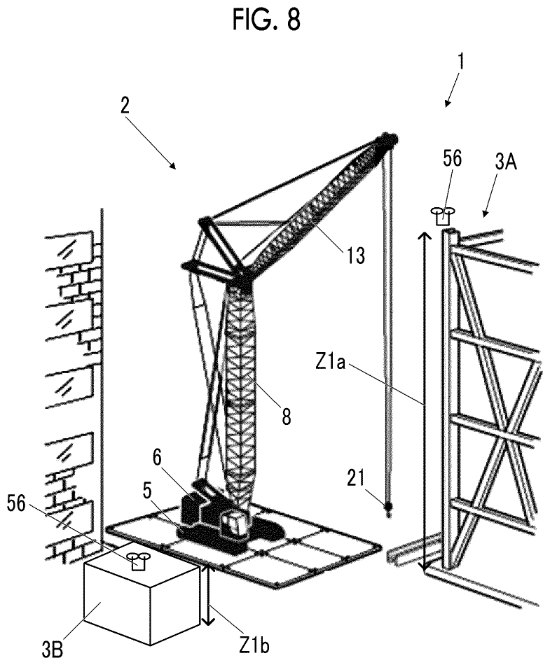

FIG. 8 is a diagram showing a fifth embodiment of the crane site obstacle determination system 1 according to the present invention, and is a diagram showing a modification example of the obstacle position designation information transmitted from the obstacle side of the crane site obstacle determination system 1. In addition, since the configuration of the crane 2 of the crane site obstacle determination system 1 according to the present embodiment is the same as that of the crane 2 of the crane site obstacle determination system 1 according to the first embodiment, the same components as those of the crane 2 of the crane site obstacle determination system 1 according to the first embodiment are denoted by the same reference numerals, and the duplicate description will be omitted.

As in the crane site obstacle determination system 1 according to the first embodiment, the crane site obstacle determination system 1 according to the present embodiment identifies the positions of obstacles 3A and 3B based on the obstacle position designation information transmitted from the obstacle 3 side. Furthermore, in the present embodiment, the obstacle position designation information includes information indicating heights Z1a and Z1b of the obstacles 3A and 3B by the following means. Hereinafter, a configuration and processing relating to the obstacle position designation information of one obstacle 3A will be described. However, the same configuration and processing can be applied to the obstacle position designation information of the other obstacle 3B.

In order to include information indicating the height Z1a of the obstacle 3A in the obstacle position designation information, in the present embodiment, the aerial vehicle 56 (for example, a drone) having a GPS function is adopted as the obstacle identification unit. The site worker operates the aerial vehicle 56 at a position away from the obstacle 3A, and moves the aerial vehicle 56 to above the obstacle 3A. Then, as the aerial vehicle 56 acquires position information including a position in a height direction at the position and transmits the position information from the aerial vehicle 56, the position information (X1, Y1, Z1a) of the obstacle 3A is input to the control unit 38 via the communication unit 45.

The above-described “above the obstacle 3A” is a concept including an upper surface of the obstacle 3A and a nearby range thereof (for example, a range within several meters from the upper surface in up-down and right-left directions).

The position information transmitted from the aerial vehicle 56 may not be completely coincident with the position information of the obstacle 3A. For example, the aerial vehicle 56 may transmit the position information of a flying location at a predetermined distance above an upper end of the obstacle 3A, and the control unit 38 may perform correction processing on the height and the position information after the correction processing may be the position information (X1, Y1, Z1a) of the obstacle 3A. Alternatively, as the correction processing is performed on the aerial vehicle 56, the position information transmitted from the aerial vehicle 56 may be the position information of the obstacle 3A (X1, Y1, Z1a).

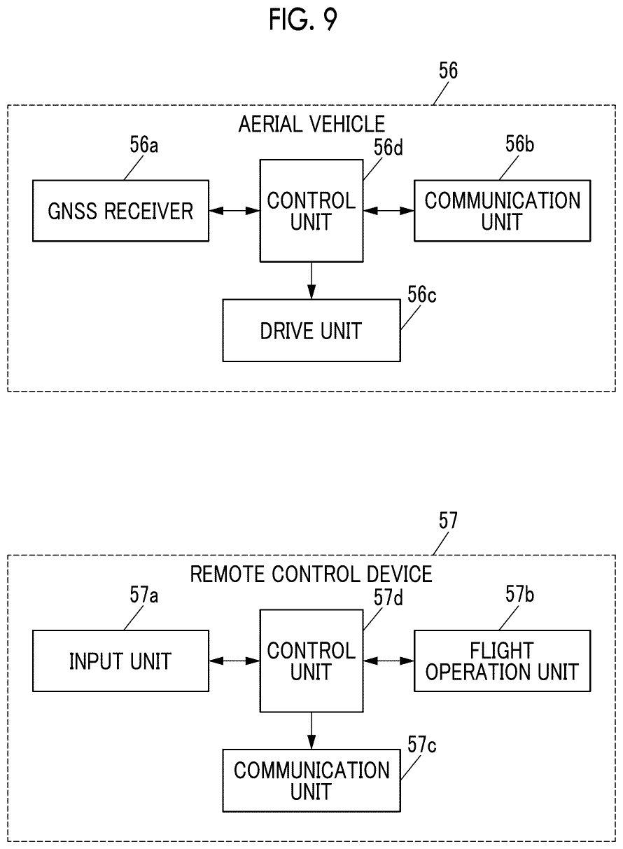

FIG. 9 is a block diagram showing a configuration of an aerial vehicle and a remote control device according to a fifth embodiment. The aerial vehicle 56 includes a GNSS receiver 56a serving as a sensor that acquires position information, a communication unit 56b that performs communication, a drive unit 56c that performs driving for flying, and a control unit 56d that controls the respective units. In the present specification, the GPS function means a positioning function using a global navigation satellite system (GNSS).

The obstacle determination system 1 further has a remote control device 57 that remotely controls the aerial vehicle 56.

The remote control device 57 includes an input unit 57a through which a processing mode selection is input and an instruction is input by a site worker, a flight operation unit 57b that performs an operation for flying the aerial vehicle 56, a communication unit 57c that communicates with the aerial vehicle 56, and a control unit 57d that executes a control process.

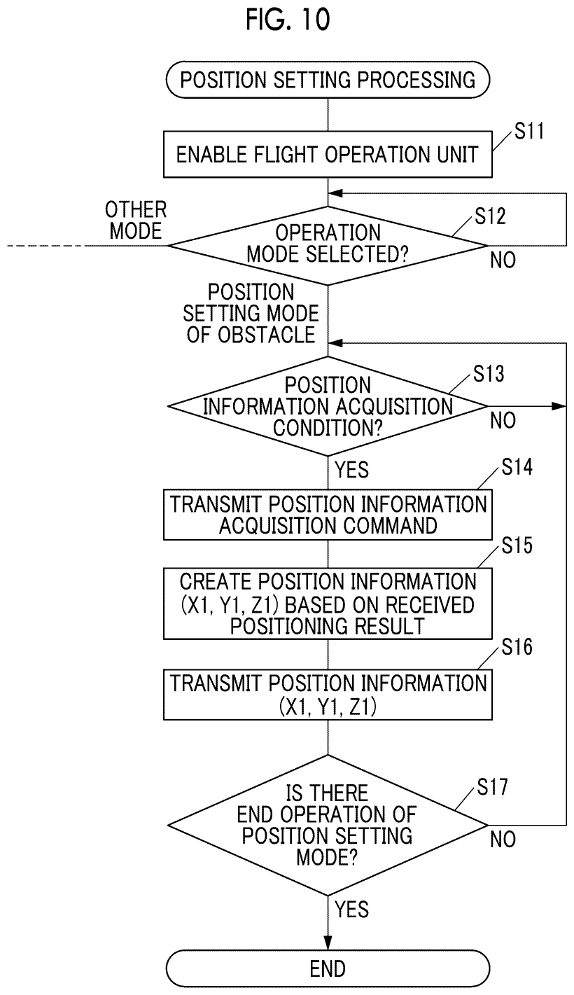

FIG. 10 is a flowchart showing an example of a procedure for position setting processing of an obstacle in the fifth embodiment. The position setting processing is executed by the control unit 57d of the remote control device 57. In the position setting processing, the control unit 57d first enables the flight operation unit 57b so that the aerial vehicle 56 can be manipulated (step S11). Next, the control unit 57d performs the processing of prompting a site worker to select an operation mode (step S12). As a result, as the site worker selects a position setting mode of the obstacle 3A, the control unit 57d advances the processing to step S13.

As the processing proceeds, the control unit 57d determines whether or not the aerial vehicle 56 satisfies a position information acquisition condition (step S13), and repeats the determination processing until the result is YES. Then, when the result is determined as YES, the control unit 57d transmits a position information acquisition command to the aerial vehicle 56 via the communication unit 57c (step S14).

In response to the acquisition command, the GNSS receiver 56a of the aerial vehicle 56 performs positioning, and the aerial vehicle 56 returns the positioning result to the remote control device 57 via the communication unit 56b. In the positioning result, height information in the vertical direction is included in addition to coordinates in a horizontal direction. Therefore, as the aerial vehicle 56 receives the position information acquisition command above the obstacle 3A, the positioning result includes information from which the height of the obstacle 3A can be obtained.

When the control unit 57d receives the positioning result via the communication unit 57c, the control unit 57d creates position information (X1, Y1, Z1) including information indicating the height of the obstacle 3A as the obstacle position designation information based on the positioning result (step S15), and transmits the position information to the control unit 38 of the obstacle determination system 1 (step S16).

Then, the control unit 57d determines whether or not an end operation of the position setting mode of the obstacle 3A is performed (step S17). In a case where the end operation is performed, the position setting processing is ended, but in a case where the end operation is not performed, the processing returns to step S13, and the processing from step S13 is repeated.

For example, the position information acquisition condition in step S13 is a condition that the aerial vehicle 56 continues hovering flight for a predetermined time (for example, several seconds). According to such an acquisition condition, the site worker moves the aerial vehicle 56 to above the obstacle 3A and causes the aerial vehicle 56 to perform hovering flight for a predetermined time there. Accordingly, the control unit 57d can acquire the positioning result at that point as the position information above the obstacle 3A. According to the adoption of the acquisition conditions, the site worker can set the position information including the height of the obstacle 3A simply by the flight operation.

In addition, the position information acquisition condition in step S13 may be other conditions. For example, the acquisition condition may be that the site worker inputs the position information acquisition command from the input unit 57a of the remote control device 57. According to such an acquisition condition, the site worker moves the aerial vehicle 56 to above the obstacle 3A and inputs the position information acquisition command there. Accordingly, the control unit 57d can acquire the positioning result at that point as the position information above the obstacle 3A. According to the adoption of the acquisition condition, the site worker can determine the position for acquiring the position information including the height of the obstacle 3A by a clear operation. Therefore, erroneous setting of the position information can be reduced.

In addition, the position information acquisition condition in step S13 may be a condition that the aerial vehicle 56 has landed. According to such an acquisition condition, the site worker lands the aerial vehicle 56 on the obstacle 3A. Accordingly, the control unit 57d can acquire the positioning result at that point as the position information above the obstacle 3A. According to adoption of the acquisition condition, the site worker can set the position information including the height of the obstacle 3A by a clear operation. According to the adoption of the acquisition condition, the site worker can set the position information including the height of the obstacle 3A simply by the flight operation and the landing operation. Furthermore, the positioning result can be information accurately reflecting the height of the obstacle 3A.

In addition, the position information acquisition condition in step S13 may be a condition that any one of two or three of the above three conditions is satisfied.

As in the crane site obstacle determination system 1 according to the first embodiment, the crane site obstacle determination system 1 according to the present embodiment can identify the position of the obstacle 3A based on the obstacle position designation information transmitted from the obstacle 3A side. Therefore, the obstacle determination on site can be more easily performed. Furthermore, since the crane site obstacle determination system 1 according to the present modification example includes information indicating the height of the obstacle 3A in the obstacle position designation information, the height of the obstacle 3A can also be identified, and the obstacle determination in three dimensions including the height direction can be performed.

In the above-described example, a configuration is shown in which the remote control device 57 sends a position information acquisition command to the aerial vehicle 56, and the positioning result is transmitted from the aerial vehicle 56 to the control unit 38 of the obstacle determination system 1 via the remote control device 57. However, the aerial vehicle 56 may determine whether or not the position information acquisition condition is satisfied and perform the positioning based on the satisfied condition, or the aerial vehicle 56 may directly transmit the positioning result to the control unit 38 of the obstacle determination system 1.

In addition, a method of identifying the position information of the obstacle 3A including the information indicating the height of the obstacle 3A by the GPS function of the aerial vehicle 56 has been shown in the above example. However, for example, a method of identifying the position information including the information indicating the height of the obstacle 3A may be adopted by using the distance measurement function of the portable terminal. In this case, the above-described portable terminal further includes a posture sensor, a camera, and a display unit in addition to the above-described distance measurement function, and outputs an image above the obstacle 3A captured by the camera to the display unit. Then, as the site worker designates the upper portion of the obstacle 3A on the display unit, the portable terminal measures the distance to above the designated obstacle 3A. Furthermore, the portable terminal calculates the elevation angle toward the above indicated position, based on the measurement result of the posture sensor. Then, the portable terminal can calculate the height of the above indicated position from the elevation angle and the distance. The site worker can identify the information indicating the height up to above the obstacle 3A from the above calculation result of the height by registering the information of the height of the position where the site worker is (for example, 1.6 m above the ground) on the portable terminal. Therefore, the portable terminal may transmit the obstacle position designation information including the information indicating the height of the obstacle 3A by using the information indicating the identified height in this way.

### Other Embodiments

Although a crawler crane has been exemplified in each of the above-described embodiments, the crane 2 of the crane site obstacle determination system 1 according to the present invention is not limited to this. For example, in addition to a mobile crane such as a wheel crane or a truck crane, the present invention can be widely applied to a harbor crane, a ceiling crane, a gantry crane, an unloader, a jig crane, a fixed crane, and the like.

The disclosure of the specification, the drawings, and the abstract included in Japanese Patent Application No. 2022-209922 filed on Dec. 27, 2022 is incorporated herein by reference in its entirety.

The present invention can be used for a crane site obstacle determination system, and a crane.

It should be understood that the invention is not limited to the above-described embodiment, but may be modified into various forms on the basis of the spirit of the invention. Additionally, the modifications are included in the scope of the invention.

What is claimed is:

1. A crane site obstacle determination system that determines an obstacle with respect to a suspended load of a crane, the system comprising:
an obstacle position identification unit that identifies a position of the obstacle based on obstacle position designation information transmitted from an obstacle side; and
an entry prohibition range determination unit that determines an entry prohibition range of the crane including the obstacle identified by the obstacle position identification unit.

2. The crane site obstacle determination system according to claim 1, further comprising:
an obstacle identification unit different from the crane,
wherein the obstacle position designation information is information emitted from the obstacle identification unit.

3. The crane site obstacle determination system according to claim 2, further comprising:
a remote control device that remotely controls the obstacle identification unit.

4. The crane site obstacle determination system according to claim 3,
wherein the remote control device includes an input unit through which a processing mode is selected and an instruction is input by a site worker, a flight operation unit that performs an operation for flying the obstacle identification unit, a communication unit that communicates with the obstacle identification unit, and a control unit that executes a control process.

5. The crane site obstacle determination system according to claim 2,
wherein the crane includes an image acquisition unit that images a periphery of the suspended load,
the obstacle position designation information is specific light emitted from the obstacle identification unit, and
the obstacle position identification unit identifies the obstacle based on detection of the light by the image acquisition unit.

6. The crane site obstacle determination system according to claim 5,
wherein the image acquisition unit is attached to an upper end side of an upper tower jib so as to image a work site from the sky.

7. The crane site obstacle determination system according to claim 5,
wherein the obstacle identification unit includes a light-emitting unit that is detachably attached to the obstacle and that reflects or emits light, and the obstacle position designation information is light emitted from the light-emitting unit.

8. The crane site obstacle determination system according to claim 2,
wherein the obstacle identification unit is an aerial vehicle having a GPS function and a distance measurement function.

9. The crane site obstacle determination system according to claim 1, further comprising:
an obstacle identification unit different from the crane; and
a first relative position detection sensor for acquiring a relative position between the crane and the obstacle identification unit,
wherein the obstacle position designation information includes information based on the first relative position detection sensor.

10. The crane site obstacle determination system according to claim 9,
wherein the obstacle identification unit includes a second relative position detection sensor that allows a relative position between the obstacle and the obstacle identification unit to be measured, and
the obstacle position designation information includes information based on the second relative position detection sensor.

11. The crane site obstacle determination system according to claim 1,
wherein the obstacle position designation information includes information indicating a height of the obstacle.

12. The crane site obstacle determination system according to claim 11,
wherein the information indicating the height is information acquired by a sensor of an aerial vehicle disposed above the obstacle.

13. A crane used by the crane site obstacle determination system according to claim 1,
wherein an operation of the crane is restricted, or a worker is notified in a case where a suspended load of the crane enters the entry prohibition range.
